(19) United States
(12) Patent Application Publication
(10) Pub. No.: US 2005/0210005 A1
(43) Pub. Date: Sep. 22, 2005

(54) Methods and systems for searching data containing both text and numerical/tabular data formats

(76) Inventors: Lee Thompson, Redding, CT (US); Eugene Eames, Newtown, CT (US)

Correspondence Address: ST. ONGE STEWARD JOHNSTON & REENS, LLC, 986 BEDFORD STREET, STAMFORD, CT, 06905-5619, US

(21) Appl. No.: 10/803,677

(22) Filed: Mar. 18, 2004

(51) Int. Cl. G06F 7/00

(52) U.S. Cl. 707/3

(57) ABSTRACT

An apparatus for generating a search report of combined data, the apparatus including a processor, a formatter coupled to the processor, the formatter formatting combined data into text data in a first format and into numerical/tabular data in a second format and storing each in storage, a search module executing on the processor, the search module searching the text data and mapping the located text data to correlated numerical/tabular data, or the search module searching the numerical/tabular data and mapping the located numerical/tabular data to correlated text data and a report module executing on the processor, the report module integrating the located and correlated text and numerical/tabular data into a report.

### FIELD OF THE INVENTION

The invention relates to methods and systems for facilitating the searching, accessing, updating and utilization of data in storage that is in both text and numerical/tabular data formats.

### BACKGROUND OF THE INVENTION

Research produced by academia and industry is a prime commodity in the information society we presently live in. One of the keys to successful research is for a researcher to maintain currency with the leading edge of technological developments in at least the particular field that the researcher is working in. Consequently, researchers are constantly trying to gain access to the most current research in their fields as well as trying to find ways to cull the information retrieved to be the most relevant according to the needs of the researcher. However, researchers face multiple problems when trying to search, retrieve, update and/or utilize research.

A first problem is that research is produced by many different entities for many different reasons and therefore each research document has its own particular data formats due to the nature of the subject matter that was researched. For example, legal research is going to generate data that is generally very text intensive whereas engineering research will usually generate data that is generally very numerical/tabular data intensive and therefore legal research and engineering research should be consider the exceptions because they generally contain data formats of one type.

In contrast, most research generated by other fields of study such as pharmaceutical, financial, medical, market research, insurance and the like produce documents in which data is generally represented in both text and numerical/tabular data formats on a regular basis. This combination of text and numerical/tabular data formats results in major difficulties when one tries to store the research data in a way that facilitates ease of searching, retrieval, updating and utilization of the research data.

For instance, numerical/tabular data formats are generally stored using relational databases and the relational databases are very good at facilitating searching, retrieval, updating and utilization of research data for numerical/tabular data formats. However, relational databases are not very good at handling free form text.

In contraposition, a text retrieval or free form database is excellent for handling research documents that are text intensive but the text retrieval databases are not good at handling research documents that have numerical/tabular data. The result of this almost inverse relationship of advantages and disadvantages between relational databases and text retrieval databases has added friction to the research process because there is presently no proficient method and/or system to facilitate searching, retrieval, updating and utilization of research data presented in both text and numerical/tabular data formats.

Because of the magnitude of the impact of the text-numerical/tabular (“combined”) data problem on academic and industry research, many attempts to solve this problem have been advanced. The most common solution has been to create a new database type that can handle the combined data formats or to create hybrid systems that combine the attributes of relational databases with the attributes of text retrieval databases. New database types that can handle the combined data formats have not been successful and the hybrid databases have resulted in databases that deliver sub-par performance.

In addition, the need to solve the combined data formats problem is further exacerbated by the accelerating pace at which research and/or general data is being produced as well as the volume of research and/or general data being produced. This accelerated pace and volume of data generation is magnifying the combined data formats problem because of data that cannot be adequately searched, retrieved, updated and utilized, which results in added costs from duplicative work, to following dead-ends, to missed opportunities to capitalize on available research.

Consequently, what is needed is a system and method to solve the combined data formats problem and to dynamically update such a data storage system in a way that is practical and less resource intensive than is presently available. What is also needed is a way to combine present public and private databases data into a data storage system that will facilitate searching, retrieval, updating and utilization of the combined data.

### SUMMARY OF THE INVENTION

Accordingly, it is an object of the present invention to provide systems and methods to facilitate searching, accessing, updating and utilization of data presented in both the text and numerical/tabular data formats.

Another object of the invention is to provide systems and methods to enable run-time storage supporting integrated full-text search capabilities and relational database functionality.

A further object of the invention is to provide systems and methods to facilitate the utilization of data in private and publicly available databases.

Still another object of the invention is to provide systems and methods to facilitate the standardization and consolidation of at least one legacy database.

Still yet another object of the invention is to provide a dynamic search-time controlled vocabulary application (“CVA”) data that is constantly updated in order to keep pace with research developments thereby providing the most complete mapping to a standardized control vocabulary.

And still a further object of the invention is to provide systems and methods to facilitate online editing of database records for authorized users as well as the generation of custom reports that enable users to make powerful comparative analyses of search results.

And still yet another object of the invention is to provide systems and methods to facilitate knowledge sharing, lower maintenance costs and eliminate duplicate records for users of a database.

And still a further object of the invention is to provide systems and methods to facilitate the searching of databases by providing a browseable and targeted CVA data.

These and other objects of the present invention are achieved by provision of an apparatus for generating a search report of combined data, the apparatus including a processor, a formatter coupled to the processor, the formatter formatting combined data into text data in a first format and into numerical/tabular data in a second format and storing each in storage, a search module executing on the processor, the search module searching the text data and mapping the located text data to correlated numerical/tabular data, or the search module searching the numerical/tabular data and mapping the located numerical/tabular data to correlated text data and a report module executing on the processor, the report module translating and integrating the located and correlated text and numerical/tabular data into a report.

Preferably, the apparatus further includes an acquisition module coupled to the processor, the acquirer acquiring combined data into the apparatus, an indexer, the indexer indexing the combined data, CVA data generated by a CVA executing on the processor, the CVA data providing a portion of a standard vocabulary that corresponds to the combined data in storage, a CVA data accessible by the processor, the CVA data having a text data portion and a numerical/tabular data portion, the CVA data expanding or reducing the text and numerical/tabular data delivered by the search module, an expert system executing on the processor, the expert system enabled to update CVA data, an editor executing on the processor, the editor providing a user with remote editing capabilities for text data and numerical/tabular data in the report, an interface in communication with the processor, the interface for inputting query data, storage accessible by the processor, the storage having stored thereon combined data, wherein the search module accesses the text data and numerical/tabular data according to the CVA data, wherein the CVA data can be browsed by a user to refine the searching performed by the search module, wherein the CVA data is updated by additions to the combined data.

Other objects of the present invention are achieved by provision of a method for generating a search report of combined data, the method including formatting combined data into text data in a first format and into numerical/tabular data in second format and storing each in storage, searching the text data and mapping the located text data to correlated numerical/tabular data, or searching the numerical/tabular data and mapping the located numerical/tabular data to correlated text data and translating and integrating the located and retrieved text and numerical/tabular data into a report.

The method further including expanding or reducing the text and numerical/tabular data delivered by the search by providing CVA data having a text data portion and a numerical/tabular data portion, normalizing the CVA data to reduce the amount of the CVA data that needs to be utilized when searching using CVA data, updating the CVA data with each addition to the text and numerical/tabular data, browsing the CVA data to control the scope of the search.

Other objects of the present invention are achieved by provision of an apparatus for generating a search report of combined data, the apparatus including a processor, storage accessible by the processor, the storage having stored thereon text data and numerical/tabular data, a CVA data executing on the processor, the CVA data having a text data portion and a numerical/tabular data portion, a search module executing on the processor, the search module searching the text data using the text data CVA data portion and mapping the search to located and correlated numerical/tabular data, or the search module searching the numerical/tabular data using the numerical/tabular data CVA data portion and mapping the search to located and correlated text data and a report module executing on the processor, the report module translating and integrating the located and correlated text and numerical/tabular data into a report.

Still other objects of the present invention are achieved by provision of a method for creating a data driven CVA data of combined data, the method including generating a CVA data, updating the CVA data with an expert system that reviews relevant combined data on an on-going basis, the expert system adjusting the CVA data according to relevant combined data and controlling the CVA data with standard vocabulary that focuses the CVA data within user defined parameters.

Yet still other objects of the present invention are achieved by provision of a method for browsing combined data in storage, the method including entering query data, analyzing the query data for synonyms, hyponyms and hypernyms (“HH”) and related terms found in a CVA data, presenting the synonyms, HHs and related terms for each term in the query data to a user for review, allowing the user to choose a synonym, HH or related term for each term in the query data and searching storage for combined data according to the modified query data.

Other objects of the present invention are achieved by provision of a system for generating a search report of combined data, the system including a processor, storage accessible by the processor, the storage having stored thereon combined data, software executing on the processor for formatting the combined data into text data in a first format and into numerical/tabular data in a second format and storing each in storage, software executing on the processor for searching the text data and mapping the located text data to correlated numerical/tabular data, or the search module searching the numerical/tabular data and mapping the located numerical/tabular data to correlated text data and software executing on the processor for translating and integrating the located and correlated text and numerical/tabular data into a report.

Other objects of the present invention are achieved by provision of a system for generating a search report of combined data, the system including a processor, storage accessible by the processor, the storage having stored thereon text data and numerical/tabular data, software executing on the processor for generating a CVA data having a text data portion and a numerical/tabular data portion, software executing on the processor for searching the text data using the text data CVA data portion and mapping the search to located and correlated numerical/tabular data, or the search module searching the numerical/tabular data using the numerical/tabular data CVA data portion and mapping the search to located and correlated text data and software executing on the processor for translating and integrating the located and correlated text and numerical/tabular data into a report.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 is a block diagram of a system for facilitating the searching of combined data within storage in accordance with an embodiment of the present invention;

FIG. 2 is a flowchart of the acquisition and formatting of combined data in accordance with the embodiment of FIG. 1.

FIG. 3 is a flowchart of the searching and report generation of first and second format combined data in accordance with the embodiment of FIG. 1; and

FIG. 4 is a block diagram of a system for facilitating the searching of combined data within storage in accordance with the embodiment of FIG. 1.

### DETAILED DESCRIPTION OF CERTAIN ADVANTAGEOUS EMBODIMENTS

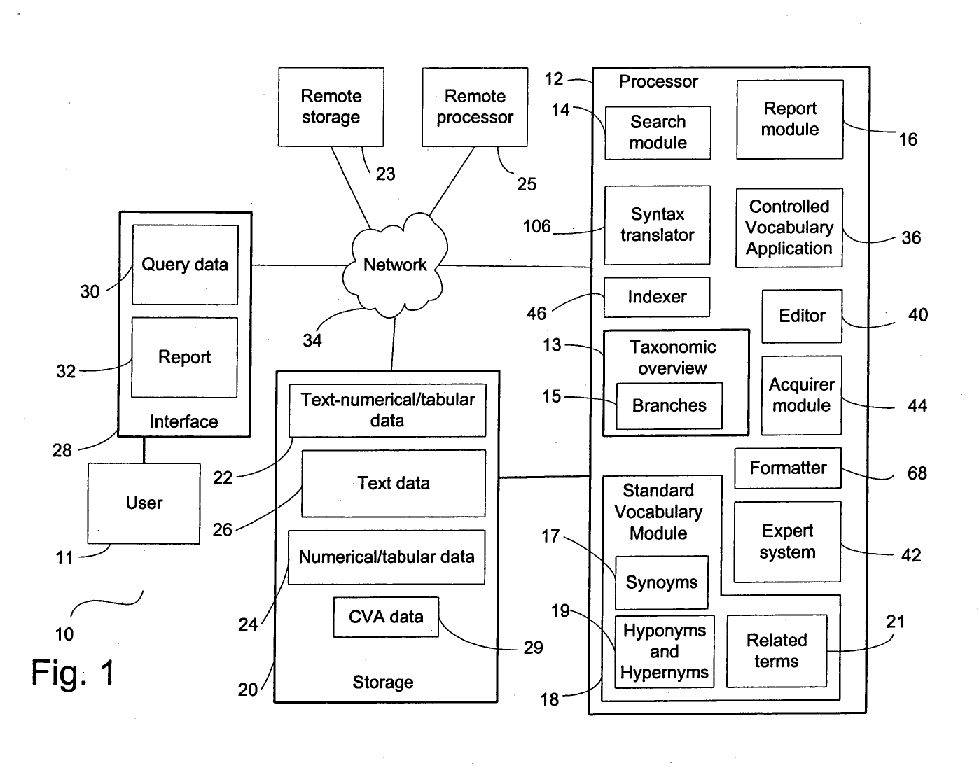

Referring now to the drawings, wherein like reference numerals designate corresponding structure throughout the views. FIG. 1 is a block diagram of system 10 for facilitating the searching of combined data 22 within storage 20 in accordance with the present invention. Combined data 22 is data that contains both text and numerical/tabular data such as pharmaceutical, financial, engineering, insurance, medical, academic research reports and the like. Storage 20 has separate storage subdivisions for combined data 22 stored as text data 26 and numerical/tabular data 24. Text data 26 is generally in a free form text format and numerical/tabular data 24 is generally in a relational format such as Quel, SQL, Oracle, and the like.

System 10 includes processor 12 having executing thereon search module 14, standard vocabulary module 18, report module 16, controlled vocabulary application (“CVA”) 36, editor 40, acquirer module 44, indexer 46 and expert system 42. SV 18 contains synonyms 17, hyponyms and hypernyms (“HH”) 19 and related terms 21. System 10 also includes network 34, remote storage 23 and remote processor 25 and storage 20 holds CVA data 29.

System 10 further includes interface 28 to provide access to system 10 for a user 11 such as a person, remote storage 23, remote processor 25, or the like. Interface 28 can be used to enter query data 30 to search for specific combined data 22 in storage 20. Query data 30 is communicated over network 34 to search module 14 and search module 14 utilizes a number of techniques to refine the search in order maximize speed and relevancy of the data returned.

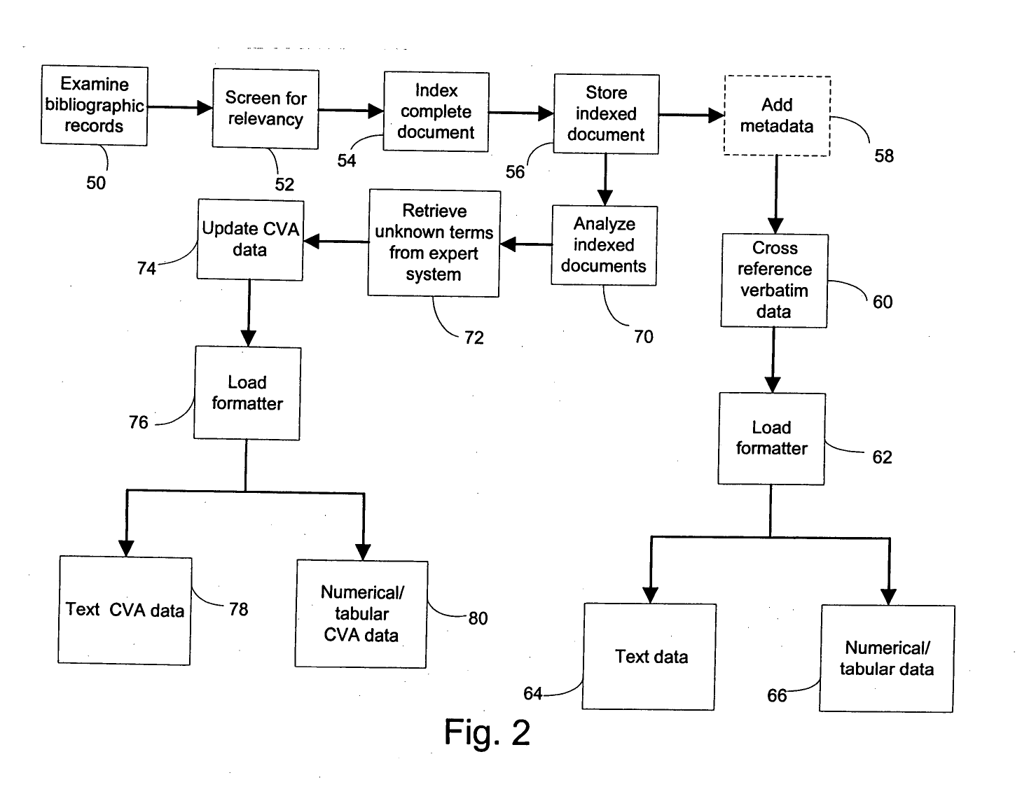

Referring now to FIG. 2, the capture of combined data 22 into system 10 is described. Bibliographic records of public and private databases are examined by acquirer module 44 for pertinent combined data 22 for a particular application, at block 50. Acquirer module 44 has the capability of receiving records in electronic format or any other format, e.g. records from public databases, emailed records in various formats from private sources, or bulk record files containing multiple records. Acquirer module 44 can also determine information, which may be in the subject line of an email record, the filename of a file, and the like, and can insert that information into the combined data 22 as a new field. Acquirer module 44 can also strip extraneous data from these acquired records and stores them in a format that formatter 68 can process. Further, acquirer module 44 has a mechanism for ordering the full text versions of any bibliographic records it acquires.

For example if system 10 is utilized by a pharmaceutical research company, acquirer module 44 would access medical and research journals as well as proprietary drug research sources to gather the most current and verified information that is relevant to the pharmaceutical user's 11 information needs, at block 52. If acquirer module 44 deems a particular document relevant to user's 11 needs, then acquirer module 44 acquires a complete copy of the document. Next, the combined data 22 of the complete document is indexed, at block 54, by indexer 46 (see FIG. 1). Indexer 46 utilizes manual indexing, automatic indexing, or a combination of both techniques, depending on combined data 22, retrieval requirements, and other factors.

The complexity of indexing can vary from simple characterization of the superficial properties of each document (e.g., type of document, author, date, etc.) to the collection of complex hierarchical data fully detailing the contents of each document covered in combined data 22. Authority lists of allowed entries are used for appropriate fields, as are standard vocabularies such as Medical Subject Headings, MeSH® (“MeSH”) or Medical Dictionary for Regulatory Activities, MedDRA® (“MedDRA”). Indexer 46 can also provide indexing based on online records alone or on the full text of documents. Regardless of indexing technique, the indexed combined data 22 is then stored in storage 20 at block 56.

In block 58, which is an optional step as indicated by dashed lines, the indexed combined data 22 then receives metadata tags such as SGML, HTML, XHTML, XML and the like. Then verbatim combined data 22 is cross-referenced with expert system 42 (see FIG. 1) at block 60 to add approved terminology. Combined data 22 is then loaded into formatter 68 (see FIG. 1), at block 62. Formatter 68 processes textual and/or numeric data into multiple formats and creates both a text data 26 file in a first format and a numeric/tabular data 24 file in a second format, at blocks 64 and 66 respectively.

For example, formatter 68 formats numeric/tabular data 24 into appropriate numeric data types for a relational database and formatter 68 can create a number of relational records for each text data 26 file in order to fully normalize text data 26. Both text data 26 and numeric/tabular data 24 can be modified with data from CVA 36 in order to add “preferred terms” to a record, or to correct mistakes in the source data. Also, formatter 68 can report on incomplete records, can be used to report on terms not found within CVA 36, and can normalize the numeric values in convertible units, e.g. “1 kilogram per hour” may be converted to “1000 grams per hour” if grams is the desired unit to be used.

CVA 36 compares the text data 26 and numeric/tabular data 24 values in storage 20 to standard vocabularies by identifying concepts, words, and phrases (“terms”). The result of this process is one or more data files, CVA data 29, which represent portions of the standard vocabularies containing terms that occur in user's 11 database. Additional information from the standard vocabularies may also be extracted and added to CVA data 29 to represent synonyms, narrower terms, and varying degrees of broader terms of those verbatim terms found in user's 11 data. Also, the vocabularies used by CVA 36 are not limited to any specific standards because any standard can be used including user's 11 own set of standards.

Additionally, CVA 36 reports on terms, which are NOT found in one or more of the standard vocabularies 18. This reporting can be done on a field-by-field basis or on a wider basis and additional tracking information can be included in report 32 to identify the exact location in combined data 22 and its source.

Referring back to FIG. 2, at block 70, the indexed combined data 22 is analyzed for terms pertinent to user's 11 field of interest by SV 18 and terms that are unknown are sent to expert system 42 to be identified, at block 72. The identified unknown terms are then added to SV 18 in block 74 and formatter 68 is loaded with updated SV 18, at block 76. Because a targeted vocabulary is desired, it is inserted at block 74. Formatter 68 then generates text data CVA data 29 and numerical/tabular data CVA data 29, at blocks 78 and 80 respectively, which will provide enhanced searching capabilities.

Search module 14 enables user 11 to identify data matching his/her query data 30, independent of whether query data 30 is text data 26 and/or numeric/tabular data 24 and a variety of input formats are used to either guide user 11 through query data 30 entry, or to allow an advanced user 11 direct access to the underlying database query data 30 formats. Regardless of how the query data 30 is entered, search module 14 queries both the text data 26 and numeric/tabular data 24 in storage 20 as needed to fulfill the requirements presented by query data 30. User 11 is generally unaware of this dual underlying search because the dual search can be performed without the interaction of user 11.

However, to enable a dual search of heterogeneous data sets using a single set of query data 30 involves the use of a syntax translator 106 because the syntax used by one search engine of search module 14 should be translated to the syntax used by the other search engine. For example: user 11 enters query data 30 for a search of documents where the Author is Smith and the number of patients studied is greater than 100. Query data 30 can be first formatted into a query string that identifies all records with Smith in the Author field of text data 26. Then, the entire query can be translated by syntax translator 106 into the format required by the numerical/tabular data 24, e.g. relational database format, to identify the same set of records as the text engine of search module 14 found, the records with Smith in the Author field.

The relational engine of search module 14 then further reduces the set of records by identifying a subset of records which also have a value greater than 100 in the Number of Patients field. The relational engine of search module 14 can also be used to calculate additional values, to sort numeric data, and to retrieve the data. In this example each data format is used for what it does best, text searches in the text database and numeric searches in the relational database, the end result being the greatest possible speed. In an alternative embodiment, search module 14 could first access the numeric/tabular data 24 and then use the results to locate the correlated text data 26 and sorting can also be done on alphabetic data using the text search engine.

A search of the indexed combined data 22 in storage 20 will employ search module 14 that utilizes searching by concept using synonyms 17, HH 19, and related terms 21, to control the data set delivered.

Synonyms utilize by search module 14 are supplied by CVA data 29. For example, a pharmaceutical user of system 10 will use CVA data 29 based on medical SV 18 derived from the National Library of Medicine's Unified Medical Language System® (UMLS®) (“UMLS”), including the MedDRA terminology, that covers most of the vocabulary of clinical medicine and pharmaceutical research. In addition, CVA 36 contains tools for the convenient management of modifications and additions that individual users may require to adapt CVA data 29 to their specific needs, including the importation of entire proprietary vocabularies.

Adapting the medical SV 18, by the CVA 36, for use with a specific proprietary database includes not only the addition of more detailed terminology in areas of special importance to a user but also permits the pruning away of irrelevant categories, which improve search efficiency and precision. The result is that CVA data 29 is truly customized for enhancing information retrieval of specific combined data 22.

The creation of targeted CVA data 29 containing the key concepts that are expected to be important for information retrieval, with all available synonyms 17, HH 19 and related terms 21 can provide many benefits, including permitting searching by concept rather than literal string and providing a navigational alternative to conventional searching by enabling CVA data 29 browsing.

When entering query data 30, user 11 can choose to use CVA data 29, to find synonymous 17, HH 19, and related terms 21 for a word or phrase user 11 has entered. In this case, text CVA data 78 first identifies a set of text data 26 documents where any of these synonymous or narrower values are found in a field specified by user 11. For instance, user 11 might search for “heart attack” as an effect, and the text CVA data expands the search to include “heart attack”, “myocardial infarction”, etc.

Search module 14 would then search for numeric/tabular data 24 for the expanded query data 30. In order for search module 14 to find the correlated set of documents in the numeric/tabular data 24, a corresponding expansion of the expanded query data 30 should be made in the numeric/tabular data 24. The same CVA expansion to synonymous and narrower terms should be made in numeric/tabular data 24 by using numerical/tabular data numerical/tabular CVA data 80 in order to identify the same set of records thereby enabling further numeric limiting, calculations, numeric sorting, and data retrieval.

A benefit of searching using CVA data 29 is that the resulting set of data is substantially the same as if the search was executed using the corresponding complete standard vocabulary but the resources necessary to execute the search are greatly reduced. This enables search module 14 greater speed at search time by avoiding the inherit limitations of a text database engine or a relational database engine as well as the limitations posed by a full thesaurus or standard vocabulary search.

Also, when multiple standard vocabularies and/or proprietary vocabularies are used, CVA data 29 can merge the resulting data when either the text data 26 or the numeric/tabular data 24 is restricted to using a single standard vocabulary or thesaurus. An additional benefit of utilizing the CVA data 29 arises when dealing with multiple standard vocabularies and/or proprietary vocabularies because browsing of the vocabularies are targeted to user's 11 specific query data 30.

Another benefit of the CVA is that it enables user 11 the ability to browse the data generated by CVA 36 as a taxonomy, which is part of CVA data 29. For example, CVA data 29 would enable user 11 to see only words and phrases closely related to their data, instead of possibly millions of entries from the full standard vocabulary that have no relationship to user's 11 data. Additionally, a “hit count” field can be used to show users 11 how many times each of the terms they are viewing in the browse mode are actually found within their data.

Search module 14 includes navigation tools that enable users 11 to utilize CVA data 29 in order to see synonymous terms, narrower terms, and broader terms of any word or phrase. With the navigational tools of search module 14, user 11 can drill up or down and can choose to examine synonymous 17, HH 19, and related terms 21 of their original query data 30. Search module 14 also includes a search feature that enables user 11 to find all CVA data 29 entries that contain a word or phrase.

The ability to navigate the CVA data 29 is useful to user 11 who enters a term and finds no matching records. This user 11 can then browse the CVA data 29, looking for broader terms which do have a hit count, indicating the term is found in user's 11 data. User 11 could also use the CVA browser's search feature to find all phrases related to a word or phrase, and from that identify an appropriate query string.

The information retrieval task is essentially that of trying to match query data 30, or information need, with some target resources, combined data 22, that one expects will answer query data 30 or satisfy that need. Given the variety of ways in which concepts can be expressed in both query data 30 and the combined data 22 searched, any effort to standardize the language of either query data 30 or combined data 22 can improve performance, e.g. such as by using CVA data 29.

In an alternative embodiment, CVA 36 indexes by adding a standard term or phrase for a concept (usually in a special field created for that purpose) whenever a synonym for that concept is encountered in combined data 22. This requires the availability of SV 18 to have the synonymous expressions for the concepts relevant in a given search environment.

Search module 14 also allows user 11 to browse concepts from general to specific and to see the synonyms that search module 14 uses when searching. For instance, CVA data 29 displays all terms appearing in combined data 22 that have been selected as the “best” entries for concepts or entities that may be described in a variety of ways. Interface 28 displays each such term in the context of broader terms (such as a category including the term), synonymous or related terms, and narrower terms. Browsing CVA data 29, starting with whatever term is of interest to user 11, can actually replace some kinds of searching.

If combined data 22 in storage 20 has already been categorized in some fashion, browsing these categories, particularly if they are meaningfully structured with hierarchies or topic-maps, can dramatically improve recall, while giving user 11 an overview of combined data 22 in storage 20 that may be more broadly helpful.

Search module 14 starts near the top of a hierarchy and browses down the tree until a level of specificity is reached that corresponds to query data 30. By proceeding in this manner, search module 14 is guaranteed of finding a high percentage of combined data 22 relevant to query data 30. Also, such a method is more congenial to users 11 who may not be experienced in constructing search strategies themselves or are unfamiliar with search module 14 because browsing displays related concepts that can often result in recognition of useful extensions to the original search that user 11 would have been unlikely to think of by themselves.

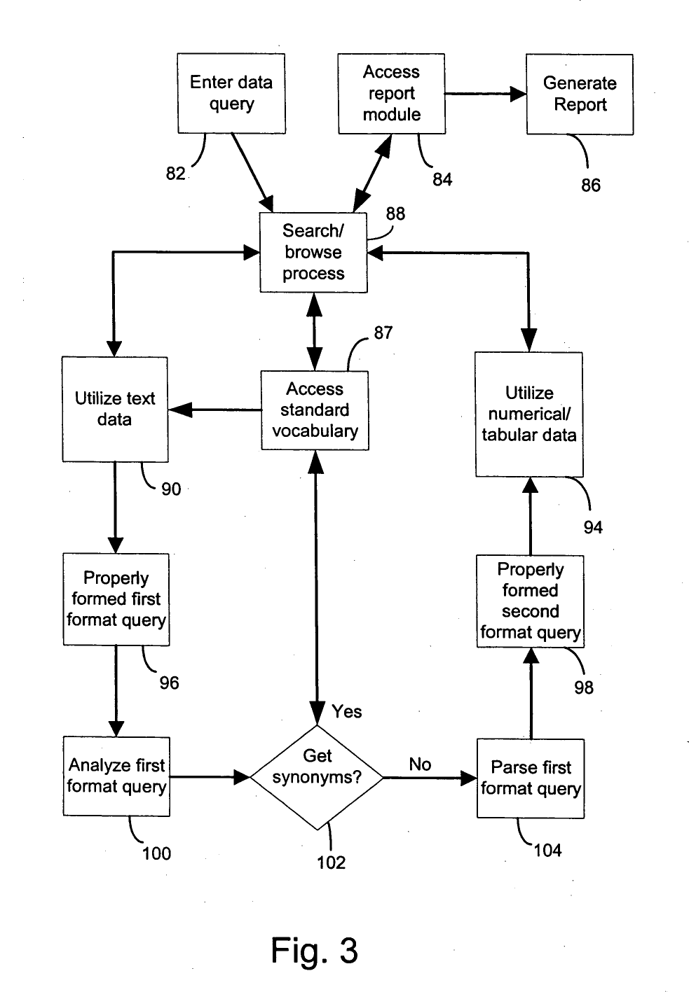

Referring now to FIG. 3, query data 30 is entered into interface 28, at block 82. Search module 14 then initiates the search/browse process, at block 88, by accessing text data 26 in storage 20, at block 90. The searched text data 26 that correlates to query data 30 is then sent to report module 16, at block 84. Also, the search process enables user 11 to browse CVA data 29 to further develop their query data 30.

Once query data 30 is cross-referenced and CVA data 29 expanded, a properly formed first format query is formed, block 96. The first format query is then analyzed, at block 100, and is checked to see if any synonyms are required for key query data 30 terms, at block 102. If system 10 requires synonyms, then CVA data 29 is accessed for relevant terms. If synonyms are not required or synonyms have been retrieved, the first format query will be parsed, at block 104. The parsing will provide a properly formed second format query, at block 98, which will be used to access numerical/tabular data 24 from storage 20, at block 94.

The searched numerical/tabular data 24 that correlates to the searched text data 26 is then integrated with the searched text data 26 in report module 16 by syntax translator 106, at block 84. The integrated numerical/tabular data 24 that correlates to the searched text data 26 is used to generate report 32, at block 86. Report 32 is the prospective data set that satisfies query data 30 that was entered in block 82.

User 11 can further customize report 32 utilizing report module 16 by selecting the addition of calculated numeric values generated from numeric/tabular data 24, the addition of fields from both the text data 26 and numeric/tabular data 24, and performing a sorting function on text data 26 and numeric/tabular data 24. In addition, report 32 can generated a summary of data from the text data 26 and/or numeric/tabular data 24 and report 32 enables user 11 to “drill down” to text data 26 and numerical/tabular data 24, which supports the summary or columnar data presented in report 32.

In an alternative embodiment of the invention, system 10 can utilize numerical/tabular data 24 to execute the search, which will then be formatted, analyzed and parsed to locate text data 26 in storage 20. The searched text data 26 that correlates to the searched numerical/tabular data 24 is then integrated with the searched numerical/tabular data 24 in report module 16 by syntax translator 106, at block 84, into report 32.

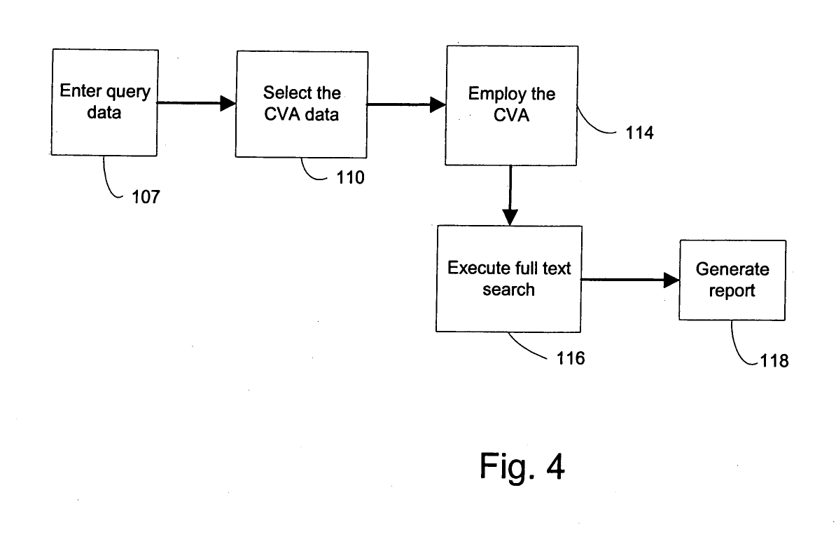

In another embodiment of the invention, system 10 can search combined data 22 in storage 20 without separating text data 26 and numerical/tabular data 24. For example, referring to FIG. 4, user 11 enters query data 30 into system 10 at block 107. User 11 can then select the CVA data 29 for the search at block 110. In an alternative embodiment, there is no selection of the CVA data 29 because a default selection of CVA data 29 is used.

At block 114, CVA 36 can present the CVA data 29 for browsing and/or expansion. For example, query data 30 is cross-referenced with CVA data 29 and the cross-referencing identifies verbatim terms, synonyms 17, HH 19, and related terms 21, which comprise the taxonomic overview 13, which is a part of CVA data 29. For instance, each verbatim term identified becomes the trunk of a taxonomic overview 13 and each synonyms 17, HH 19, and related terms 21 becomes a branch 15. Unused branches 15 of CVA data 29 are discarded by system 10 during CVA 36 process as being superfluous thereby reducing system 10's access time for finding data as well as reducing the amount of resources necessary to employ a full text search of text data 26, block 116. The results of block 116 are used by report module 16 to generate report 32 at block 118.

System 10 can also generate a taxonomic overview 13 of query data 30, which can be presented to user 11 on interface 28 to enable browsing of a listing of expanded or restricted query data 30 terms that can be utilized by search module 14. For instance, an identified verbatim term becomes the trunk of a taxonomic overview 13 of combined data 22 and each synonyms 17, HHs 19, and related terms 21 becomes a branch 15 representing combined data 22. Also, as before, unused branches 15 of SV 18 are discarded by CVA 36 as being superfluous thereby enabling user 11 to select branches 15 that are appropriate for their search of query data 30.

System 10 also provides that search module 14 is browseable by user 11 utilizing taxonomic overview 13 of combined data 22. The taxonomic overview 13 of combined data 22 is presented to user 11 to browse a listing of CVA data 29 terms, which will be utilized by search module 14 to fine tune the searching being executed by search module 14, at block 118. When the final search terms of CVA data 29 are selected, search module 14 accesses storage 20 to retrieve relevant combined data 22 and generate report 32, at block 120.

Although the invention has been described with reference to a particular arrangement of parts, features and the like, these are not intended to exhaust all possible arrangements or features, and indeed many other modifications and variations will be ascertainable to those of skill in the art.

1. An apparatus for generating a search report of combined data, the apparatus comprising:
a processor;
a formatter executing on the processor for formatting the combined data into text data in a first format and into numerical/tabular data in a second format and storing each in storage;
a search module executing on the processor for searching the text data and mapping the located text data to correlated numerical/tabular data, or the search module searching the numerical/tabular data and mapping the located numerical/tabular data to correlated text data; and
a report module executing on the processor for integrating the located and correlated text and numerical/tabular data into a report.

2. The apparatus of claim 1 further comprising controlled vocabulary application data accessible by the processor, the controlled vocabulary application data providing a portion of a standard vocabulary that corresponds to the combined data in storage.

3. The apparatus of claim 2 wherein at least one of the text data and the numeric/tabular data uses multiple standard vocabularies.

4. The apparatus of claim 3 wherein the report can integrate the controlled vocabulary application data when at least one of the text data and the numeric/tabular data is restricted to using a single standard vocabulary.

5. The apparatus of claim 4 wherein the search module accesses the text data and numerical/tabular data according to the controlled vocabulary application data.

6. The apparatus of claim 2 wherein the controlled vocabulary application data has a text data portion and a numerical/tabular data portion.

7. The apparatus of claim 6 wherein the controlled vocabulary application data can be browsed by a user to refine the searching performed by the search module.

8. The apparatus of claim 6 wherein the controlled vocabulary application data is updated by additions to the combined data.

9. The apparatus of claim 1 further comprising an editor executing on the processor for providing a user with remote editing capabilities for text data and numerical/tabular data in the report.

10. A method for generating a search report of combined data, the method comprising:
formatting combined data into text data in a first format and into numerical/tabular data in second format and storing each in storage;
searching the text data and mapping the located text data to correlated numerical/tabular data, or searching the numerical/tabular data and mapping the located numerical/tabular data to correlated text data; and
integrating the located and retrieved text and numerical/tabular data into a report.

11. The method of claim 10 further comprising limiting the text and numerical/tabular data available to a search by controlled vocabulary application data having a text data portion and a numerical/tabular data portion.

12. The method of claim 11 further comprising normalizing the controlled vocabulary application data to reduce the amount of a standard vocabulary that needs to be utilized when searching using the controlled vocabulary application data.

13. The method of claim 11 further comprising updating the controlled vocabulary application data with each addition to the text and numerical/tabular data.

14. The method of claim 11 further comprising browsing the controlled vocabulary application data to control the scope of the search.

15. An apparatus for generating a search report of combined data, the apparatus comprising:
a processor;
storage accessible by the processor, the storage having stored thereon text data and numerical/tabular data;
controlled vocabulary application data accessible by the processor, the controlled vocabulary application data having a text data portion and a numerical/tabular data portion;
a search module executing on the processor for searching the text data using the text data controlled vocabulary application data portion and mapping the search to located and correlated numerical/tabular data, or the search module searching the numerical/tabular data using the numerical/tabular data controlled vocabulary application data portion and mapping the search to located and correlated text data; and
a report module executing on the processor for translating and integrating the located and correlated text and numerical/tabular data into a report.

16. The apparatus of claim 15 wherein the controlled vocabulary application data can be browsed and selected by a user to refine the scope of the searching performed by the search module.

17. The apparatus of claim 15 wherein the controlled vocabulary application data is updated by additions to the combined data.

18. The apparatus of claim 15 further including an expert system executing on the processor for controlling the updating of the controlled vocabulary application data.

19. A method for creating data driven controlled vocabulary application data of combined data, the method comprising:
generating controlled vocabulary application data by removing unrelated terms from a standard vocabulary;
updating the controlled vocabulary application data with an expert system that reviews relevant combined data on an on-going basis and adjusts the controlled vocabulary application data according to relevant combined data; and
limiting the controlled vocabulary application data by user defined parameters.

20. A method for browsing combined data in storage, the method comprising:
entering query data;
analyzing the query data for synonyms, hyponyms, hypernyms, and related terms found in controlled vocabulary application data;
presenting the synonyms, hyponyms, hypernyms, and related terms for each term in the query data to a user for review;
allowing the user to chose a synonym, hyponyms, hypernyms, or related term for each term in the query data; and
searching storage for combined data according to the modified query data.

21. The method of claim 20 further comprising allowing the user to chose a synonym, hyponyms, hypernyms, or related term for each term in the modified query data.

22. The method of claim 20 further comprising restricting the synonyms, hyponyms, hypernyms, and related terms presented to the user by controlled vocabulary application data.

23. A system for generating a search report of combined data, the system comprising:
a processor;
storage accessible by the processor, the storage having stored thereon text data and numerical/tabular data;
software executing on the processor for generating controlled vocabulary application data having a text data portion and a numerical/tabular data portion;
software executing on the processor for searching the text data using the text data controlled vocabulary application data portion and mapping the search to located and correlated numerical/tabular data, or the search module searching the numerical/tabular data using the numerical/tabular data controlled vocabulary application data portion and mapping the search to located and correlated text data; and
software executing on the processor for translating and integrating the located and correlated text and numerical/tabular data into a report.

24. A system for generating a search report of combined data, the apparatus comprising:
a processor;
storage accessible by the processor, the storage having stored thereon combined data;
software executing on the processor for formatting the combined data into text data in a first format and into numerical/tabular data in a second format and storing each in storage;
software executing on the processor for searching the text data and mapping the located text data to correlated numerical/tabular data, or the search module searching the numerical/tabular data and mapping the located numerical/tabular data to correlated text data; and
software executing on the processor for integrating the located and correlated text and numerical/tabular data into a report.

25. An apparatus for generating a search report of combined data, the apparatus comprising:
a processor;
storage accessible by the processor, the storage having stored thereon combined data;
a formatter coupled to the processor for formatting the combined data into text data in a first format and into numerical/tabular data in a second format and storing each in storage;
controlled vocabulary application data accessible by the processor, the controlled vocabulary application data having a text data portion and a numerical/tabular data portion;
a search module executing on the processor, the controlled vocabulary application data limiting the search module search of the text data, the search module mapping the located text data to correlated numerical/tabular data, or the controlled vocabulary application data limiting the search module searching the numerical/tabular data, the search module mapping the located numerical/tabular data to correlated text data; and
a report module executing on the processor, the report module translating and integrating the located and correlated text and numerical/tabular data into a report.

26. An apparatus for targeting data for a search, the apparatus comprising:
a processor;
a standard vocabulary accessible by the processor;
a controlled vocabulary application executing on the processor, the controlled vocabulary application reducing the standard vocabulary to a targeted version of the standard vocabulary; and
a search module executing on the processor for searching the targeted version of the standard vocabulary.

27. The apparatus of claim 26 wherein the search module enables browsing of the targeted version of the standard vocabulary.
